(19) United States
(12) Patent Application Publication
(10) Pub. No.: US 2016/0017920 A1
(43) Pub. Date: Jan. 21, 2016

(54) RADIAL BEARING ASSEMBLY, IN PARTICULAR FOR AN UNBALANCED SHAFT

(71) Applicants: Riad Bauch, Wurzburg (DE); Eve Goujon, Wurzburg (DE); Norbert Huhn, Schweinfurt (DE)

(72) Inventors: Riad Bauch, Wurzburg (DE); Eve Goujon, Wurzburg (DE); Norbert Huhn, Schweinfurt (DE)

(73) Assignee: AKTIEBOLAGET SKF, Goteborg (SE)

(21) Appl. No.: 14/801,302

(22) Filed: Jul. 16, 2015

(30) Foreign Application Priority Data
Jul. 18, 2014 (DE) 102014214004.8

(51) Int. Cl. F16C 33/58; F16C 19/26; F16C 33/66

(52) U.S. Cl. CPC F16C 33/585; F16C 33/6681; F16C 19/26

(57) ABSTRACT

A radial bearing assembly for supporting an outer part with respect to an inner part, which parts are rotatable relative to each other about a common longitudinal axis, the radial bearing assembly including a bearing seat formed on the outer part or on the inner part and having a width that varies over a circumference of the bearing seat, and assembly including at least one rolling-element in line contact with the bearing seat. The bearing seat includes at least one interruption configured such that the at least one rolling element is supported by the bearing seat along the entire circumference of the radial bearing assembly and such that at least part of the at least one rolling element makes line contact with the bearing seat along the entire circumference of the radial bearing assembly.

### CROSS-REFERENCE

This application claims priority to German patent application no. 10 2014 214 004.8 filed on Jul. 18, 2014, the contents of which are fully incorporated herein by reference.

### TECHNOLOGICAL FIELD

The present disclosure relates to a radial bearing assembly for supporting an outer part with respect to an inner part, in particular for supporting an unbalanced shaft in a housing, and to an unbalanced shaft supported by such a radial bearing assembly.

### BACKGROUND

A radial bearing assembly for supporting an outer part with respect to an inner part is known from the prior art, for example, from EP 2014935 (corresponding to US 2007/177837). This reference shows an arrangement in which the outer part and the inner part rotate with respect to each other about a common longitudinal axis. A bearing seat is formed on the outer part or on the inner part of the bearing assembly, and the bearing seat includes a load zone that is subject to a radial load that is substantially stationary relative to the bearing seat. Load zones of this type occur, in particular, on bearing seats supporting unbalanced shafts, that is, shafts having a center of gravity that is not rotationally symmetric relative to the longitudinal axis about which the shaft rotates in a housing. In order to support the corresponding loads generated by the unbalanced shaft, the inner ring or the outer ring must be appropriately dimensioned.

In conventional radial bearings it has been recognized that the bearing seat is subjected to a significantly lower load or even to no mechanical load outside the load zone. It has therefore been proposed to provide the bearing seat with a width that varies over its circumference, that is, a bearing seat that is significantly tapered outside the load zone. For the person skilled in the art this means that the width of the bearing seat continuously decreases from a first bearing width defined in the load zone until a second bearing width outside the load zone is reached. This design also results in a large weight savings. In addition, improved rolling element lubrication can be achieved because the rolling elements locally and temporarily protrude beyond the width of the bearing seat. This allows lubricant to be guided directly onto the rolling elements.

Furthermore, if the rollers or needles outside the load zone are subjected to centrifugal force acting in the direction of the housing, the bearing seat need not extend completely over the 360° circumference of the shaft. Instead, the bearing seat can be broken or interrupted outside the load zone in order to save weight.

A person of ordinary skill in the art will recognize that an “interrupted” bearing seat is one that, instead of tapering as usual with a gradual reduction from a region having a greater width to a region having a smaller width, will taper in width until no more material is present.

Disadvantageously, when such a conventional bearing stops rotating, there is nothing to support the rolling elements in the region of the interruption.

The rolling elements are thus not subject to sufficient outward or centrifugal force, and in the interruption region the rolling elements are freely movable in the housing or in the bearing cage and can change their position in the rolling-element bearing in an undesirable manner. However, each new starting operation presupposes that all rolling elements are properly positioned before a sufficient centrifugal force effect has been achieved. If the rolling elements are not sufficiently precisely positioned, because, for example due to a lack of support, they have left their position during stoppage, damage to the bearing assembly can result.

### SUMMARY

The object of the present disclosure is therefore to provide a radial bearing assembly, particularly suited for supporting an unbalanced shaft in a housing, which is reduced in weight and allows for improved bearing lubrication, but which at the same time prevents rolling elements from leaving predetermined positions when the bearing is not rotating.

According to the disclosure a radial bearing assembly for supporting an outer part with respect to an inner part, in particular for supporting an unbalanced shaft relative to a housing, is provided. The outer part and the inner part are rotatable with respect to each other about a common longitudinal axis. Here the radial bearing assembly comprises a bearing seat formed on the outer part or the inner part, which bearing seat is substantially stationary relative to a radial load acting on the bearing seat in a load zone and has a width that varies over its circumference. Furthermore, the radial bearing assembly is configured as a rolling-element bearing having line contact with at least one rolling element, which rolling element contacts the bearing seat along a line. Examples of rolling-element bearings having line contact include, for example, radial needle bearings, cylindrical roller bearings, tapered roller bearings, and toroidal roller bearings. The lubrication of the rolling elements is problematic in rolling-element bearings having line contact because lubricant cannot reach all points of the elongated rolling element. The bearing seat is provided with a smaller width outside the load zone than inside the load zone so that lubricant can at least contact the end regions of the rolling elements. In addition, at least one interruption is provided on the bearing seat that allows lubricant to reach the rolling elements in the region of the interruption, while still allowing the bearing seat to provide line support for the roller elements over its entire circumference. As mentioned above, the lubricant can thereby reach all regions of the rolling element. Furthermore, according to the disclosure the rolling elements are supported by the bearing seat over the entire circumference of the radial bearing assembly, so that the rolling elements are prevented from falling out or being displaced even during stopping and starting processes.

According to a further advantageous exemplary embodiment the interruption has a length whose longitudinal direction is angled relative to the line contact of the rolling elements. This angled orientation helps ensure that the rolling elements are supported by the bearing seat over its entire circumference.

It is particularly advantageous if the interruption is configured as a lubricant channel. As a result lubricant can be guided via the interruption onto the rolling elements so that the lubricant can reach a central region of the line contacting rolling elements. This allows particularly good lubrication to be provided over the entire length of the rolling elements, particularly since the central region of the rolling elements is the region having the highest stress load.

According to a further advantageous embodiment, the bearing seat has a different width parallel to the longitudinal axis in the load zone and outside the load zone. Specifically, the bearing seat has a first axial width parallel to the longitudinal axis outside the load zone and has a second axial width parallel to the longitudinal axis in the load zone, and the first axial width is smaller than the second axial width. The transition from the first axial width to the second axial width advantageously can occur gradually; however it is also possible to form the transition stepwise. This allows material to be saved and weight to be reduced so that outside the load zone the radial bearing assembly is not over dimensioned. This in turn reduces costs and reduces the overall weight of a vehicle.

Furthermore, it is advantageous if, outside the load zone, the bearing seat extends obliquely to a rolling direction of the at least one rolling element, and inside the load zone the bearing seat extends substantially parallel to the rolling direction of the at least one rolling element. As a result particularly good support of the rolling elements can also be ensured outside the load zone. The oblique design simultaneously makes it possible for lubricant to reach all regions of the rolling elements.

Outside the load zone the bearing seat can advantageously include an undulation or serration in the axial direction, which may advantageously be Z-shaped or M-shaped. These shapes have the advantage that on the one hand they are easy to produce, and on the other hand offer good support for the rolling elements over the circumference of the bearing.

According to a further advantageous exemplary embodiment the outer part is configured as a housing and the inner part as a shaft supported in the housing. Here the bearing seat having a varying width can be formed on the shaft or in the housing. In the first case the radial load rotates with the shaft, while in the second case the radial load is substantially stationary relative to the housing. An embodiment of this type includes an unbalanced shaft, that is, a shaft whose center of gravity is eccentric to the longitudinal axis. When a bearing assembly supports shafts of this type, one part of the bearing is more heavily loaded than another part of the bearing. In order to ensure sufficient overall support, the load region of the radial bearing assembly must be sized accordingly. This also means that conventional radial bearing assemblies are often overdimensioned in the unloaded region. Using the inventive design, weight can be saved and the supplying of lubricant can be significantly improved. This helps ensure a reduced friction and functionally reliable operation and which significantly improves the service life of the radial bearing assembly. Specifically, the inventive radial bearing assembly helps provide particularly good lubrication of the rolling elements over their entire raceway width which significantly increases the service life of the radial bearing assembly.

At the same time the inventive alignment of the interruption helps ensure that the rolling elements are supported over the entire circumference of the shaft and are not left free or left pressed against the raceway formed on the housing only by centrifugal force. In this way damage or susceptibility to failure can be significantly reduced.

A further aspect of the present disclosure therefore relates to an unbalanced shaft that is supported in a housing using the above-described radial bearing assembly.

Further advantages and advantageous embodiments are defined in the claims, the description, and the drawings.

In the following discussion, embodiments of the disclosure will be described in more detail with reference to exemplary embodiments depicted in the drawings. Here the exemplary embodiments are of a purely exemplary nature and are not intended to limit the scope of the application. This scope is defined solely by the appended claims.

### BRIEF DESCRIPTION OF THE DRAWINGS

FIG. 1 is a schematic plan view of part of a first exemplary embodiment of a radial bearing assembly according to the present disclosure.

FIG. 2 is a schematic depiction of an alternate running-surface shape for a radial bearing assembly according to the present disclosure.

FIG. 3 is a schematic depiction of a further alternative running-surface shape for a radial bearing assembly according to the present disclosure.

FIG. 4 is a schematic plan view of part of a second exemplary embodiment of a radial bearing assembly according to the present disclosure.

### DETAILED DESCRIPTION

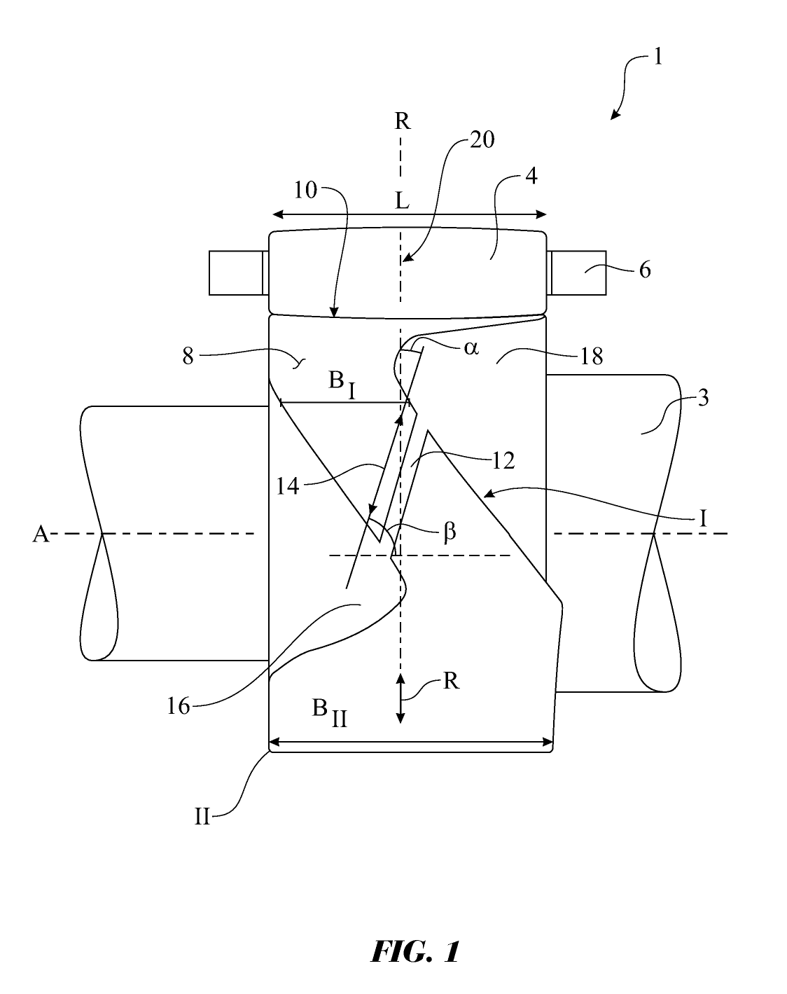

FIG. 1 shows a radial bearing assembly 1 for a shaft 3 on which a bearing seat 2 is formed. The bearing seat advantageously forms a running surface 8 for a rolling element that is retained by a cage 6. FIG. 1 further shows that the shaft 3 and thus the bearing seat 2 rotate about a common axis of rotation A, such that the rolling elements 4 move along the bearing seat 2 in the direction R. The running surface 8 is formed on the bearing seat 2, and the rolling elements 4 contact the running surface 8 along a line 10, that is, they are in line contact with the running surface.

Since the rolling elements 4 are configured to contact the running surface 8 of the bearing seat 2 along the line 10, a so-called “contact line,” the rolling-element bearing 1 may also be referred to as a rolling-element bearing having line contact. Here the rolling elements 4 themselves can have a cylindrical shape, like the depicted needle bearing; however, it is also possible to use tapered or toroidal rolling elements. Only ball bearings, bearings that make point contact with the running surfaces, are not considered to be rolling-element bearings having line contact.

Furthermore, it can be seen in FIG. 1 that the bearing seat 2 includes a first partial section I and a second partial section II, and that an axial width BI of the running surface 8 in the first partial section I is smaller than an axial width BII of the running surface 8 in the second partial section II. Here the axial width BI, BII are measured in a direction substantially parallel the axis of rotation A.

Furthermore, FIG. 1 shows an interruption 12 in the form of a lubricant channel in the first partial section I. The lubricant channel 12 extends over the entire width BI of the bearing seat 2 so that lubricant can be guided from both axial sides onto the rolling elements 4. Furthermore, the longitudinal axis 14 of the lubricant channel 12 is not parallel to the axis of rotation A and is not perpendicular to the movement direction R of the rolling elements 4, but rather is oblique thereto and forms an angle β with the longitudinal axis A and an angle α with the movement direction of the rolling elements 4 so that the rolling elements 4 are always supported by the surface 8 of the bearing seat 2. Furthermore, the angled orientation of the interruption 12 generates a preferred pumping direction of the lubricant with respect to the movement direction R of the rolling elements 4, so that lubricant is guided through the channel and thus onto all regions of the rolling-element 4.

The lubricant channel 12 is open to the running surface 8 so that lubricant can easily be delivered from the lubricant channel 12 onto the rolling elements 4.

Since the running surface 8 has a smaller width BI in the first partial section I than in the second partial section II, recesses 16, 18 are formed in the bearing seat 2 of the rolling-element bearing 1 on the running surface in the first partial section I, and the rolling elements 4 are not supported by the bearing seat 2 over these recesses 16, 18. Additional lubricant, for example in the form of a lubricant mist, can reach directly through these recesses onto the rolling elements 4 so that the rolling elements 4 also come into contact with lubricant at the locations where they would be contacting a running surface of a conventional bearing seat.

In order to deliver lubricant to all possible points of the rolling elements 4, the first partial section I of the running surface 8 does not extend parallel to the rolling direction R (which is substantially perpendicular to the axis of rotation A), but rather is oblique relative to the rolling direction R. Thus in the first partial section I lubricant can be applied to the rolling elements 4 along their entire length L, and this helps ensure that adequate lubricant is provided, especially, in a central region 20 of the rolling element 4.

As can be further seen in FIG. 1, the recesses 16, 18, or in other words the skewing of the first partial section I of the running surface 8, can be configured such that the recesses 16, 18 each extend up to or beyond the central region 20 of the rolling elements so that direct lubrication of the central region 20 of the rolling elements 4 is possible.

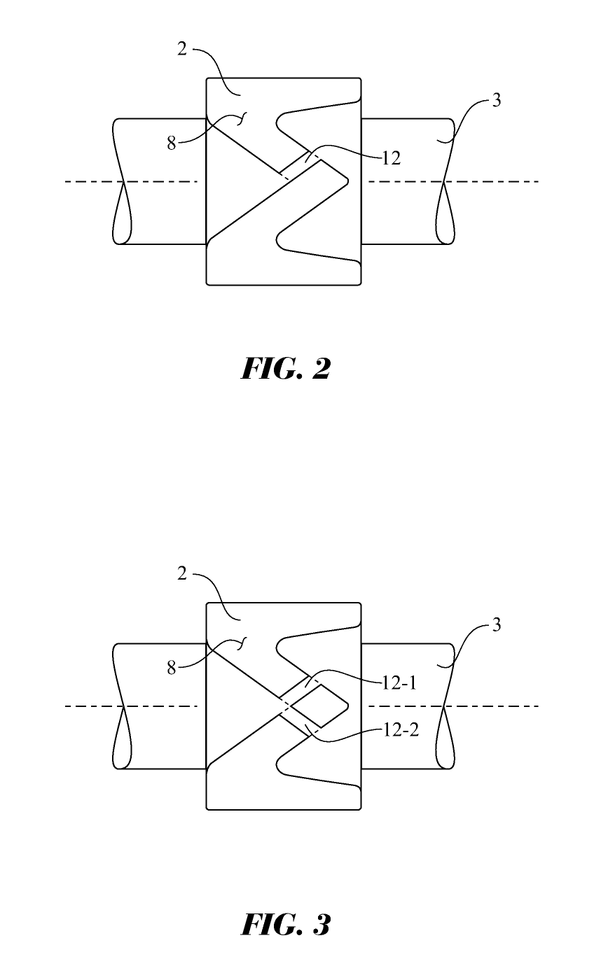

FIG. 1 shows a Z-shaped design of the running surface 8; however it is also possible to select another axially oblique design for the running surfaces. Thus, for example, FIG. 2 shows a design of the raceway 8 with a double skewing configured as a serration so that the running surfaces 8 assume an M-shaped design. A particularly good guiding of lubricant onto the rolling elements 4 is also ensured in this exemplary embodiment.

The lubricant channel 18 itself can be straight, as depicted, or curved. It is also possible for the lubricant channel to extend in an undulating or serrated manner over the width of the bearing seat, or, as shown in FIG. 3 a plurality of lubricant channels may be provided. In the exemplary embodiment of FIG. 3 the two lubricant channels 12-1, 12-2 are set at an angle to each other.

Furthermore, the lubricant channel can be formed alternatively or additionally in the second partial section II. In this way the supply of lubricant can also be significantly improved in this second partial section II. Such a design is possible in the load zone because, due to the inventive design, the rolling elements are always supported by the bearing seat even in the region of the lubricant channel.

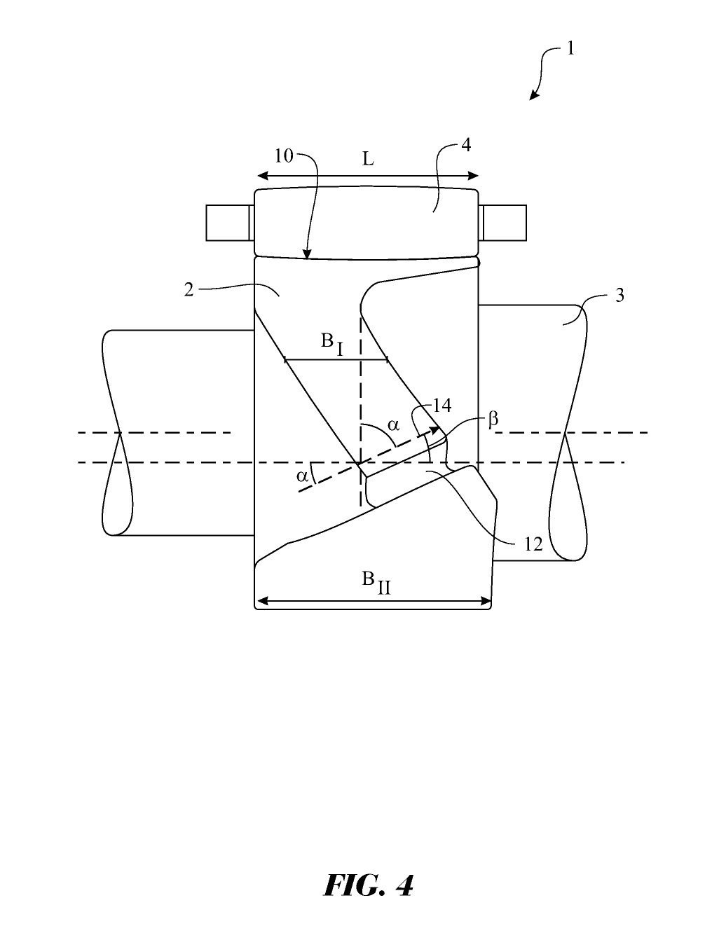

FIG. 4 shows a further advantageous design in which the angular setting a is not so steeply embodied as in FIG. 1. However, in this exemplary embodiment it can also be seen that the rolling elements 4 are always supported along at least a large part of their contact line 10 by the running surface 8 of the bearing seat 2.

Overall, using the inventive radial bearing assembly 1 the supply of lubricant to rolling elements can be improved. Because the bearing seat supports the rolling elements over the entire circumference of the radial bearing assembly, i.e., even in a region of an interruption in the bearing seat, a displacing or slipping of the rolling elements can be reliably prevented. In addition, lubricant can be guided directly to the rolling elements 4 due to the obliquely extending running surface in a partial section I of the rolling-element bearing 1.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved radial bearing assemblies.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Radial bearing assembly
2 Bearing seat
3 Shaft
4 Rolling elements
6 Cage
8 Surface
10 Contact line
12 Lubricant channel
14 Longitudinal direction of the lubricant channel
16, 18 Recesses
20 Central region of the rolling elements
A Axis of rotation
R Rolling direction of the rolling elements
I First partial section
II Second partial section
BI Width of the running surface in the first partial section
BII Width of the running surface in the second partial section
L Length of the rolling elements
α Angle between the longitudinal direction of the lubricant channel and the rolling direction R
β Angle between the longitudinal direction of the lubricant channel and axis of rotation A or the contact line

We claim:

1. A radial bearing assembly for supporting an outer part with respect to an inner part, wherein the outer part and the inner part are rotatable relative to each other about a common longitudinal axis, the radial bearing assembly comprising:
a bearing seat formed on the outer part or on the inner part, the bearing seat being configured to be substantially stationary relative to a radial load applied to the bearing seat in a load zone, the bearing seat having a width that varies over a circumference of the bearing seat,
wherein the radial bearing assembly includes at least one rolling-element in line contact with the bearing seat, and
wherein at least one interruption is formed on the bearing seat and configured such that the at least one rolling element is supported by the bearing seat along the entire circumference of the radial bearing assembly and such that at least part of the at least one rolling element makes line contact with the bearing seat along the entire circumference of the radial bearing assembly.

2. The radial bearing assembly according to claim 1, wherein the interruption has a length that is not parallel or perpendicular to a line along which the at least one rolling-element makes line contact with the bearing seat.

3. The radial bearing assembly according to claim 1, wherein the interruption is configured as a lubricant channel.

4. The radial bearing assembly according to claim 1, wherein the bearing seat has a first axial width parallel to the longitudinal axis outside the load zone and a second axial width parallel to the longitudinal axis in the load zone, the first axial width being smaller than the second axial width.

5. The radial bearing assembly according to claim 1, wherein outside the load zone the bearing seat extends obliquely to a rolling direction of the at least one rolling element, and wherein inside the load zone the bearing seat extends substantially parallel to the rolling direction of the at least one rolling element.

6. The radial bearing assembly according to claim 5, wherein outside the load zone the bearing seat has an undulation or a serration in the axial direction.

7. The radial bearing assembly according to claim 5, wherein outside the load zone the bearing seat has a Z-shape or an M-shape.

8. The radial bearing assembly according to claim 1, wherein the outer part is a housing, the inner part is a shaft supported in the housing, and the bearing seat is formed on the shaft and has a width that varies around its circumference, and wherein the radial load rotates with the shaft.

9. The radial bearing assembly according to claim 1, wherein the outer part is a housing, the inner part is a shaft supported in the housing, and the bearing seat is formed in the housing and wherein the radial load is substantially stationary relative to the housing.

10. The radial bearing assembly according to claim 8, wherein the shaft is an unbalanced shaft having a center of gravity eccentric to a longitudinal axis of the shaft.

11. A system comprising an unbalanced shaft and a radial bearing assembly according to claim 1.

12. The radial bearing assembly according to claim 1,
wherein the interruption has a length that is not parallel or perpendicular to a line along which the at least one rolling-element makes line contact with the bearing seat,
wherein the interruption is configured as a lubricant channel,
wherein the bearing seat has a first axial width parallel to the longitudinal axis outside the load zone and a second axial width parallel to the longitudinal axis in the load zone, the first axial width being smaller than the second axial width,
wherein outside the load zone the bearing seat extends obliquely to a rolling direction of the at least one rolling element, and wherein inside the load zone the bearing seat extends substantially parallel to the rolling direction of the at least one rolling element,
wherein outside the load zone the bearing seat has an undulation or a serration in the axial direction, and
wherein the outer part is a housing, the inner part is a shaft supported in the housing, and the bearing seat is formed on the shaft and has a width that varies around its circumference, and the radial load rotates with the shaft.

13. The radial bearing assembly according to claim 4, wherein the interruption comprises at least one channel in the bearing seat.

14. The radial bearing assembly according to claim 13, wherein the at least one channel has a first channel end at a first axial side of the bearing seat and a second channel end at a second axial side of the bearing seat and wherein the second channel end is axially and circumferentially spaced from the first channel end.

15. The radial bearing assembly according to claim 14, wherein the bearing seat has a first axial width parallel to the longitudinal axis outside the load zone and a second axial width parallel to the longitudinal axis in the load zone, the first axial width being smaller than the second axial width and wherein the at least one channel is located outside the load zone.

16. A radial bearing assembly for supporting a shaft for rotation relative to a housing, the radial bearing assembly comprising:
a bearing seat formed on the shaft or on the housing, the bearing seat having an axial width that varies around a circumference of the bearing seat; and
at least one rolling-element that makes line contact with the bearing seat,
wherein the bearing seat includes at least one interruption configured and arranged such that the at least one rolling element makes line contact with the bearing seat over at least part of the axial length of the at least one rolling-element around the entire circumference of the bearing seat.

17. The radial bearing assembly according to claim 16, wherein the interruption comprises at least one channel in the bearing seat.

18. The radial bearing assembly according to claim 17, wherein the at least one channel has a first channel end at a first axial side of the bearing seat and a second channel end at a second axial side of the bearing seat and wherein the second channel end is axially and circumferentially spaced from the first channel end.

19. The radial bearing assembly according to claim 18, wherein the bearing seat has a first axial width parallel to the longitudinal axis outside the load zone and a second axial width parallel to the longitudinal axis in the load zone, the first axial width being smaller than the second axial width and wherein the at least one channel is located outside the load zone.
